(19) United States
(12) Patent Application Publication
(10) Pub. No.: US 2026/0288414 A1
(43) Pub. Date: Sep. 24, 2026

(54) MULTIPLE-INPUT FUSED MULTIPLY-AND-ACCUMULATE UNIT FOR THE LOGARITHM NUMBER SYSTEM

(71) Applicant: Taiwan Semiconductor Manufacturing Company Ltd., Hsinchu (TW)

(72) Inventors: Brian Crafton, Hsinchu (TW); Xiaochen Peng, Hsinchu (TW); Ashwin Sanjay Lele, Hsinchu (TW)

(73) Assignee: Taiwan Semiconductor Manufacturing Company Ltd., Hsinchu (TW)

(21) Appl. No.: 19/086,839

(22) Filed: Mar. 21, 2025

(51) Int. Cl. G06F 7/544; G06F 7/485; G06F 7/487

(52) U.S. Cl. CPC G06F 7/5443; G06F 7/485; G06F 7/4876

(57) ABSTRACT

Memory devices, circuits, and a method of operating the same are disclosed. In one aspect, a multiply-accumulate (MAC) circuit includes one or more circuits. The one or more circuits can receive a first operand and a second operand formatted according to a logarithm number system, and generate a plurality of sums based on the first operand and the second operand. The one or more circuits can determine a plurality of exponential values using a fraction portion of the plurality of sums. The one or more circuits can generate a mantissa portion for a floating-point value based on the exponential values, and generate an exponent portion for the floating-point value based on an integer portion of the plurality of sums. The one or more circuits can provide the floating-point value as output.

### BACKGROUND

The semiconductor industry has experienced rapid growth due to continuous improvements in the integration density of a variety of electronic components (e.g., transistors, diodes, resistors, capacitors, etc.). For the most part, this improvement in integration density has come from repeated reductions in minimum feature size, which allows more components to be integrated into a given area.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a diagram of an example accelerator circuit including multiply-accumulate (MAC) circuits for the logarithm number system, in accordance with some embodiments.

FIG. 2 illustrates a diagram of an example MAC circuit for the logarithm number system, in accordance with some embodiments.

FIG. 3 illustrates a diagram of an example exponential function circuit that may be implemented as part of the example MAC circuits described herein, in accordance with some embodiments.

FIG. 4 illustrates a data flow diagram showing how an example MAC operation can be performed using the example MAC circuit of FIG. 2, in accordance with some embodiments.

FIG. 5 illustrates a flowchart of example method of operating the example MAC circuits described herein, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Accelerator circuits can use dedicated MAC circuits to perform various floating-point operations, such as dot products, convolutions, or matrix multiplications, among others. To improve the performance of such circuits, and to reduce computational complexity, memory usage, or energy consumption, higher-precision floating-point values (e.g., 32-bit floating point values, 16-bit floating point values) may be quantized to lower-precision values (e.g., 4-bit floating point values in the E2M1 format, etc.). However, this loss of precision can result in a marked reduction in the accuracy of resulting MAC operations performed using the quantized values relative to their unquantized counterparts.

One approach to mitigating this reduction in accuracy is to use the logarithm number system to represent operands, rather than quantized floating-point values. The logarithmic number system represents numbers as logarithms, simplifying multiplication, division, and exponentiation to fixed-point addition and subtraction. This simplification can lead to significant improvements in accuracy, area efficiency, and energy efficiency compared to traditional floating-point systems. When using the logarithmic number system, the hardware required for multiplication and division is reduced, which can result in smaller, less power-hungry circuits. The logarithmic number system can be used for a variety of mathematical operations, including those implemented in artificial intelligence, such as dot products and MAC operations, where the benefits of efficient multiplication and division improve overall system performance.

The present disclosure provides various techniques for implementing MAC circuits that utilize the logarithm number system to represent binary numbers, thereby improving the accuracy and efficiency of mathematical operations. The MAC circuits described herein can be fused multiple-input MAC circuits. The MAC circuits described herein can generate floating-point output to maintain compatibility with various circuits, including other types of arithmetic or logical circuits. The MAC circuits described herein can be integrated in accelerator circuits to provide significant improvements in accuracy, area efficiency, and energy efficiency for a variety of applications, including artificial intelligence operations, compared to traditional floating-point systems.

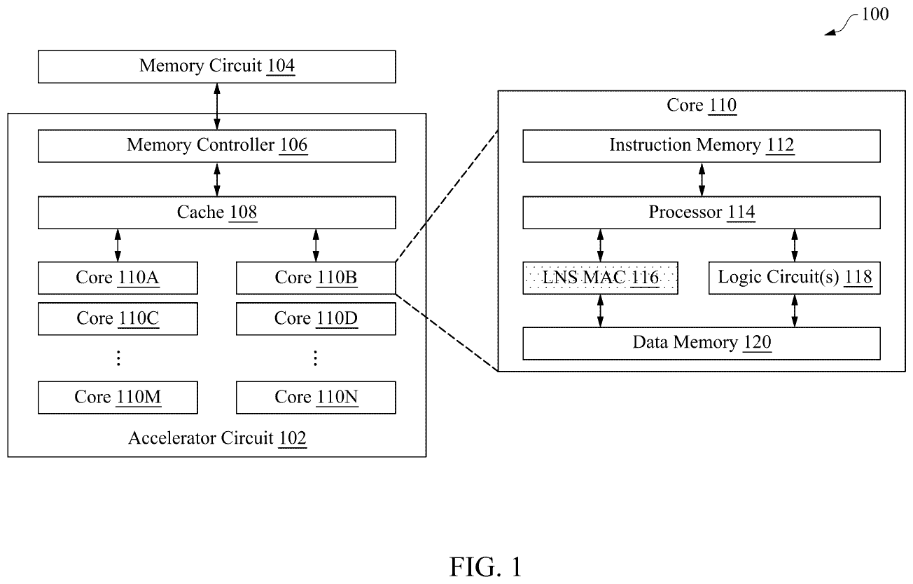

FIG. 1 illustrates a diagram 100 of an example accelerator circuit 102 including MAC circuits for the logarithm number system, in accordance with some embodiments. The accelerator circuit 102 can be included in any type of processing device or computing system. In some implementations, the accelerator circuit 102 is provided as an individual integrated circuit (IC) device. In some implementations, the accelerator circuit 102 is included as a part of a larger IC device which comprises circuitry other than the memory device for other functionalities. The diagram 100 is shown as including an accelerator circuit 102 and a memory circuit 104. The accelerator circuit 102 is shown as including at least one memory controller 106, at least one cache 108, one or more cores 110A-110N (sometimes referred to generally herein as the “core(s) 110”). The core 110 is shown as including instruction memory 112, at least one processor 114, at least one logarithm number system MAC circuit 116, one or more logic circuit(s) 118, and data memory 120.

Each of the components shown in the diagram 100 may receive power from one or more voltage sources. The components shown in the diagram 100 may include one or more logic gates and sub-circuits, each of which may be constructed from one or more logic gates. Logic gates are electronic devices that perform logical operations on one or more input signals to produce a single output signal.

Various embodiments of the circuits and logic gates that implement the components shown in the diagram 100 may include various transistors. The transistors described herein may have a certain type (n-type or p-type), but embodiments are not limited thereto. The transistors can be any suitable type of transistor including, but not limited to, metal oxide semiconductor field effect transistors (MOSFET), complementary metal oxide semiconductors (CMOS) transistors, P-channel metal-oxide semiconductors (PMOS), N-channel metal-oxide semiconductors (NMOS), bipolar junction transistors (BJT), high voltage transistors, high frequency transistors, P-channel and/or N-channel field effect transistors (PFETs/NFETs), FinFETs, planar MOS transistors with raised source/drains, nanosheet FETs, nanowire FETs, or the like.

The diagram 100 is shown as including at least one accelerator circuit 102. The accelerator circuit 102 can be an accelerator for a variety of mathematical operations, including operations involving parallel processing or machine learning, such as matrix multiplication, convolution, or neural network processing. The accelerator circuit 102 can be integrated into a processing device or computing system, for example, as a co-processor or as a peripheral device, to accelerate specific types of computations, thereby improving overall system performance. The accelerator circuit 102 may be implemented as part of any suitable processing device, including but not limited to graphics processing unit(s) (GPUs), field-programmable gate arrays (FPGAs), general-purpose processors (e.g., with parallel processing capabilities, etc.), or any other type of processing device or system. The accelerator circuit 102 can be used for different types of applications, such as artificial intelligence systems, scientific simulations, data analytics, or computer vision, among others. In some implementations, the accelerator circuit 102 can be used to accelerate specific tasks, such as MAC operations.

The diagram 100 is shown as including at least one memory circuit 104. The memory circuit 104 can be a type of memory, such as dynamic random-access memory (DRAM), static random-access memory (SRAM), or other types of memory, which can store data in a binary format. The memory circuit 104 can interact with the accelerator circuit 102, for example, by providing the accelerator circuit 102 with input data to be processed, or by storing the results of computations performed by the accelerator circuit 102. The memory circuit 104 can store different types of data, such as program instructions, neural network models, or multimedia data, among others. In some implementations, the memory circuit 104 can store temporary results of computations, allowing the accelerator circuit 102 to access the data quickly and efficiently. The memory circuit 104 can be a memory array, a hierarchical arrangement of memory, or any other type of storage device in communication with the accelerator circuit 102.

The accelerator circuit 102 is shown as including at least one memory controller 106. The memory controller 106 can be a hardware circuit that manages access to the memory circuit 104, controlling the flow of data between the memory circuit 104 and other components of the accelerator circuit 102, such as the cores 110. The memory controller 106 can interact with the cores 110 to manage parallel access to the memory circuit 104, such that multiple cores 110 can access the memory circuit 104 simultaneously without conflicts. In some implementations, the memory controller 106 can access the cache 108 to populate the cache 108 with frequently accessed data, reducing the time it takes for the cores 110 to access the data. The memory controller 106 can perform various memory management functions. In some implementations, the memory controller 106 may optimize memory access to the memory circuit 104 for specific applications, such as scientific simulations or machine learning workloads, among others.

The accelerator circuit 102 is shown as including at least one cache 108. The cache 108 can be accessible by the cores 110. In some implementations, the cache 108 can be a level 2 (L2) cache. The cache 108 can interact with the memory controller 106, which can populate the cache 108 with data from the memory circuit 104 to reduce the time it takes for the cores 110 or other elements of the accelerator circuit 102 to access the data. In some implementations, the cache 108 can be a multi-level cache, with multiple levels of cache hierarchy.

The accelerator circuit 102 is shown as including one or more cores 110. The cores 110 can be processing units that execute instructions, such as arithmetic instructions, load/store instructions, or control flow instructions, among others. The cores 110 can interact with other components of the accelerator circuit 102, such as the memory controller 106 or the cache 108 to access data stored in the memory circuit 104, or to store results of computations in the memory circuit 104. In some implementations, multiple cores 110 can execute in parallel to perform parallel processing tasks, such as graphics processing tasks, dot product operations, matrix multiplication operations, convolution operations, or artificial intelligence operations, among others. The cores 110 can execute different types of instructions, such as logarithm number system instructions, integer instructions, floating-point instructions, or vector instructions, among others, to perform various operations.

Each core 110 can include at least one instruction memory 112. The instruction memory 112 can be a type of memory that stores instructions, such as program instructions, which can be executed by the processor 114 of the core 110. For example, the instruction memory 112 can provide instructions to be executed to the processor 114 and/or store instructions that have been prefetched from the memory circuit 104 or the cache 108. In some implementations, the instruction memory 112 can store specialized instructions, such as logarithm number system instructions, integer instructions, floating-point instructions, or vector instructions, among others, to perform various operations. In some implementations, the instruction memory 112 can include one or more caches, buffers, or any other type of storage device capable of storing instructions.

Each core 110 can include at least one processor 114. The processor 114 can be a central processing unit that executes instructions stored in the instruction memory 112, such as program instructions, to perform various operations. The processor 114 can access the instruction memory 112 to retrieve instructions and can access the logarithm number system MAC circuit 116 and/or other logic circuits 118 to various operations. In some implementations, the processor 114 can access data stored in the data memory 120.

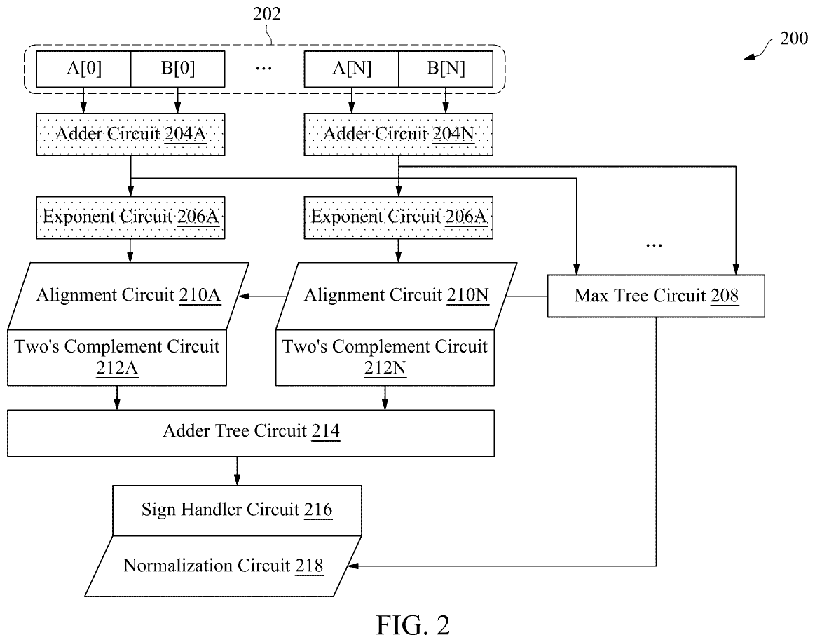

Each core 110 can include at least one logarithm number system MAC circuit 116. The logarithm number system MAC circuit 116 can be a hardware circuit that performs mathematical operations, such as multiplication and accumulation, using values in the logarithmic number system format. The logarithm number system MAC circuit 116 can communicate with other components of the core 110 and/or the accelerator circuit 102 to perform MAC operations using operands in the logarithm number system format. In some implementations, the logarithm number system MAC circuit 116 can store output values in the data memory 120 of the core 110 and/or the cache 108 of the accelerator circuit 102. In some implementations, the logarithm number system MAC circuit 116 can receive input operands in the logarithm number system format and generate output in a floating-point format. Further details of the logarithm number system MAC circuit 116 are described in connection with FIG. 2.

Each core 110 may include one or more logic circuit(s) 118. The logic circuit(s) 118 can be, for example, arithmetic logic units (ALUs) or digital signal processing (DSP) circuits, among others, to perform various arithmetic operations, including but not limited to various arithmetic calculations or transformations, bitwise operations, or modulo operations, among others. The logic circuit(s) 118 can be invoked via the processor(s) 114, which can execute instructions that specify the operation to be performed by the logic circuit(s) 118. The logic circuit(s) 118 can store or retrieve data from the data memory 120, for example, as part of one or more load or store operations. In some implementations, the logic circuit(s) 118 can perform various operations, such as logical operations, including bitwise AND, OR, or XOR operations, or arithmetic operations, including addition, subtraction, multiplication, or division, among others. In some implementations, the logic circuit(s) 118 may perform application-specific operations, such as cryptographic operations (e.g., encryption or decryption), or coding theory operations (e.g., error correction or detection), among others. In some implementations, the logic circuit(s) 118 can be programmable, allowing the processor(s) 114 to configure the logic circuit(s) 118 to perform custom operations, or to implement new instructions, among others.

Each core 110 may include at least one data memory 120. The data memory 120 can be any type of memory circuit capable of storing data, including but not limited to operands having the logarithmic number system format, results of computations, or intermediate values, which can be accessed by the processor 114, the logarithm number system MAC circuit 116, the logic circuit(s) 118, or other components of the core 110. In some implementations, the data memory 120 can store different types of data, such as vectors, matrices, or tensors, or portions thereof, which can be used in various operations, such as matrix multiplication, convolution, or neural network processing. In some implementations, the data memory 120 can be a multi-port memory, allowing multiple components of the core 110 to access the data memory 120 simultaneously. The data memory 120 may include, but is not limited to SRAM, DRAM, flash memory, or combinations thereof.

Referring to FIG. 2 in the context of the components described in connection with FIG. 1, illustrated is a diagram of an example MAC circuit 200 for the logarithm number system, in accordance with some embodiments. The MAC circuit 200 may be implemented, for example, as the logarithm number system MAC circuit 116 of FIG. 1. For example, the MAC circuit 200 may be implemented in one or more processing cores of an accelerator circuit, or in any other type of processing device (e.g., a general-purpose processor, a microcontroller, etc.). In some implementations, the MAC circuit 200 is provided as an individual IC device. In some implementations, the MAC circuit 200 is included as a part of a larger IC device which comprises circuitry other than the memory device for other functionalities. The MAC circuit 200 is shown as receiving operand data 202. The MAC circuit 200 is shown as including one or more adder circuits 204A-204N (sometimes generally referred to as the “adder circuit(s) 204”), one or more exponent circuits 206A-206N (sometimes generally referred to as the “exponent circuit(s) 206”), a max tree circuit 208, one or more alignment circuits 210A-210N (sometimes generally referred to as the “alignment circuits circuit(s) 210”), one or more two's complement circuits 212A-212N (sometimes generally referred to as the “two's complement circuit(s) 212”), an adder tree circuit 214, a sign handler circuit 216, and a normalization circuit 218.

Various embodiments of the circuits and logic gates that implement the MAC circuit 200 may include various transistors. The transistors described herein may have a certain type (n-type or p-type), but embodiments are not limited thereto. The transistors can be any suitable type of transistor including, but not limited to, MOSFET, CMOS transistors, PMOS, NMOS, BJT, high voltage transistors, high frequency transistors, PFETs/NFETs, FinFETs, planar MOS transistors with raised source/drains, nanosheet FETs, nanowire FETs, or the like. It should be understood that the MAC circuit 200 shown in FIG. 2 can be a portion of a larger processing circuit that includes memory elements and/or additional logic gates.

In this example, the MAC circuit 200 can be a fused multiple-input MAC circuit. For example, the MAC circuit 200 can perform multiple MAC operations in a single step. The MAC circuit 200 can perform The MAC circuit 200 can perform MAC operations using input operand data 202 having the logarithm number system format. The MAC circuit 200 is shown as performing a MAC operation on two operands to generate a resulting product sum. In some implementations, the MAC circuit 200 can receive a respective single input value from two operands, rather than multiple input values as shown. The output generated by the MAC circuit 200 can be a floating-point value, as described in further detail herein.

The MAC circuit 200 is shown as receiving a set of operand data 202. The operand data 202 can include a plurality of binary numbers, which can be formatted according to the logarithm number system format, thereby allowing for efficient multiplication, division, and exponentiation operations, as described herein. The operand data 202 can be received by the MAC circuit 200 from a data memory 120, cache memory 108, an accelerator circuit 102, from a processor or other memory device, among others. In some implementations, an external circuit may convert a floating-point value into the logarithm number system to generate the operand data 202, for example, by quantizing the floating-point value to a predetermined precision. In some implementations, the quantization may be performed to reduce the size of one or more parameters of an artificial intelligence model, such as a large language model.

The logarithmic number system can be used to represent numbers using their logarithms rather than their linear values. Compared to traditional floating-point representations, logarithmic number system can, on average, provide greater accuracy for a given bit-width, as the spacing of representable numbers is more uniform across the range of magnitudes. This improved precision can reduce numerical errors in applications like deep learning, simulations, or any other field that implements floating-point values. Numbers stored according to the logarithm number system can be represented using a sign value, an integer value, and a fraction value, where the number can be calculated according to the following formula:

$$Log 4 Number = {( - 1 )}^{sign} \times {2}^{integer - bias} \times {2}^{\frac{fraction}{N}}$$

In the above generic formula, “bias” represents a predetermined value used to designate the range of exponents around zero and may be different for different integer bit widths. For example, the bias may be decimal “1” when an integer bit width of 2 is used, or may be seven (e.g., binary “0111”) when an integer bit width of four is used. The value of N can represent the resolution of the fractional component of the logarithm number and may be equal to 2 raised to the number of bits in the fraction component of the logarithmic number. Numbers stored according to different example 4-bit logarithmic number (sometimes referred to herein as “I2F1,” as described in further detail herein) can be represented using a one-bit sign value, a two-bit integer value, and a one-bit fraction value:

$$Log 4 Number = {( - 1 )}^{sign} \times {2}^{integer - 1} \times {2}^{\frac{fraction}{N}}$$

In the above example, the bias value is equal to decimal “1” and the value of Nis equal to decimal 2. The set of operand data 202 can include binary values representing numbers in the logarithm number format. Example values represented using the I2F1 format can have the sign bit as the most significant bit, the integer bits as the middle two bits, and the fraction bit as the least significant bit, in some implementations. The I2F1 format is only one example of a value in the logarithm number format, and it should be understood that any type of value represented in the logarithm number format can be used in connection with the techniques described herein.

The set of operand data 202 can include two operands, shown as the vectors A and B, where each value of the input operands can be represented using the logarithm number format. For example, the vector A can include values A[0] through A[N], and the vector B can include values B[0] through B[N], where each value can be represented as a binary number in the logarithm number format, such as the I2F1 format. As shown, corresponding pairs of values, such as A[0] and B[0], A[1] and B[1], through A[N] and B[N], of the operands 202 can be processed by the MAC circuit 200 in parallel. The MAC circuit 200 can perform MAC operations on the corresponding pairs of values, using the components of the MAC circuit 200, to generate a resulting product sum.

The MAC circuit 200 can include one or more adder circuits 204. Each adder circuit 204 can be structured as a full adder or any other type of adder circuit that can add two binary values. For example, each adder circuit 204 can include multiple logic gates, such as XOR gates, AND gates, and OR gates, that can perform the binary addition operation. Each adder circuit 204 can receive and sum the exponents (e.g., the integer bits concatenated with the fraction bits), of each pair of operand values (e.g., A[0] and B[0]). The sum in this example can include the same number of fraction bits and the same number of integer bits as each operand value. The addition of the exponent of each operand is equivalent to a multiplication operation in another number format. The fraction component of the sum produced by each adder circuit 204 can be provided to a corresponding exponent circuit 206. The integer component of each sum generated by each adder circuit can be provided to the max tree circuit 208. The adder circuits 204 can be designed to operate in parallel, allowing the MAC circuit 200 to perform multiple MAC operations for multiple values of the set of input operand data 202 simultaneously.

The MAC circuit 200 can include one or more exponent circuits 206. Each exponent circuit 206 can generate a floating-point value in the linear domain, using the fraction component of the sum provided by the corresponding adder circuit 204. The exponent circuit 206 can generate the value

$${2}^{\frac{fraction}{2}}$$

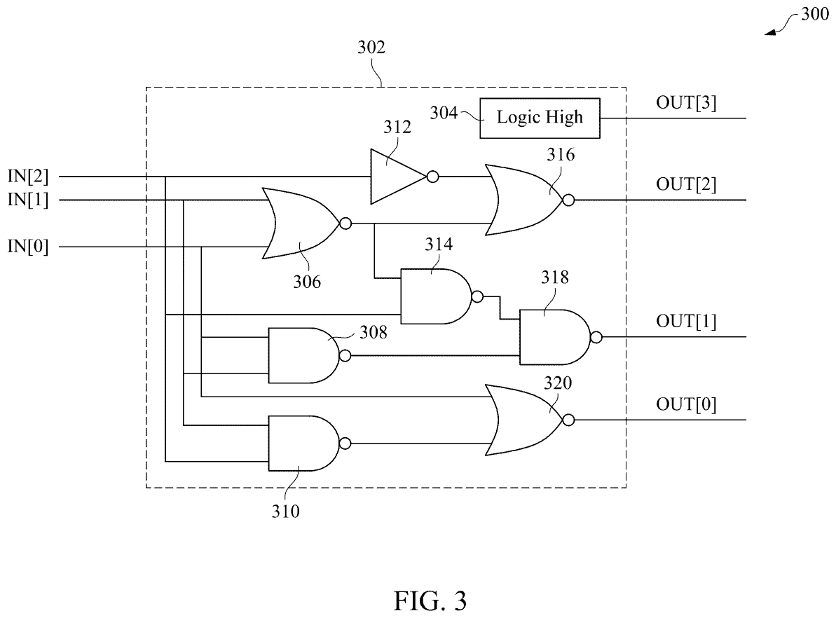

in fixed-point format, where “fraction” is the fraction component of the sum generated by the corresponding adder circuit. The fixed-point format can be structured such that only one digit precedes the decimal point. The precision of the fixed-point value generated by each exponent circuit 206 can be selected according to a target precision of the output of the MAC circuit 200. In some implementations, the exponent circuit 206 can operate as a lookup table, which may be established using logic gates or a memory element, such as a read-only memory (ROM) lookup table. An example exponent circuit 206 is described in further detail in connection with FIG. 3.

The MAC circuit 200 can include a max tree circuit 208. The max tree circuit 208 can be any type of circuit that implements a “max” operation, in which the largest value from a set of input values is provided as output. The max tree circuit 208 can receive the integer component of each sum generated by each adder circuit 204 and provide the maximum integer component as output. In some implementations, the max tree circuit 208 can be structured in various ways, such as a binary tree, a multi-level tree, or any other type of tree structure that can compare and select the maximum value from the integer components. In one example, the max tree circuit 208 can include multiple comparator circuits that can compare the integer components in a hierarchical manner, such that the max tree circuit 208 can select the maximum integer component. The max tree circuit 208 can provide the maximum integer component to each of the alignment circuits 210, which can use this value to align the output of the exponent circuits 206. In this example, the max tree circuit 208 can be designed to operate in parallel with one or more components of the MAC circuit 200.

The MAC circuit 200 can include one or more alignment circuits 210. Each alignment circuit 210 can receive the fixed-point output of the corresponding exponent circuits 206 and right-shift the fixed-point output by the max value output of the max tree circuit 208 minus the integer component of the adder circuits 204. The shifting operation performed by the alignment circuit 210 can align the operands to the largest exponent of all operands. In some implementations, the right-shift overflow can be truncated from the output of each alignment circuit 210. The alignment circuits 210 can be implemented using a combination of logic gates and shift registers. For example, in some implementations, each alignment circuit 210 can include at least one subtraction circuit that subtracts the integer component provided from the corresponding adder circuit 204 from the maximum integer value generated by the max tree circuit 208. Furthering this example, each alignment circuit 210 can include one or more shifter circuits that perform the shift operation according to the difference, including but not limited to barrel shift circuits, serial shift register circuits, or cascaded multiplexor circuits, among others. The output of each alignment circuit 210 can be provided to a corresponding two's complement circuit 212.

The MAC circuit 200 can include one or more two's complement circuits 212. Each two's complement circuit 212 can convert the unsigned shifted value generated by the corresponding alignment circuit 210 into a fixed-point two's complement value including the sign bit. In some implementations, the sign resulting from the multiplication operation may be generated using the corresponding adder circuit 204. To generate the sign bit for the multiplication operation between each pair of values of the set of input operands 202 (e.g., A[0] and B[0], etc.), the adder circuits 204 can include at least one XOR gate that generates a resulting XOR of the signs of each value in the pair. For example, if one sign bit is “1” and the other is “0” the XOR operation can output a “1” as the resulting sign bit, as the multiplying a negative number by a positive number results in a negative number. Furthering this example, if both sign bits are “1” or both sign bits are “0”, the XOR operation can output a “0” as the resulting sign bit, as multiplying two negative values or two positive values results in a positive product.

The sign bit can be used to cover the shifted value into two's complement format, such that the adder tree circuit 214 can efficiently add products generated by the adder circuits 204, the exponent circuits 206, the max tree circuit 208, and the alignment circuits 210. To perform the conversion, the two's complement circuit can add an additional most-significant bit to the value, and initially set this bit to “0.” If the resulting sign bit generated via the corresponding adder circuit 204 is “0”, indicating a positive number, the two's complement circuit 212 can provide this binary value as output, as the output is now in two's complement format for a positive value (e.g., with the most significant bit representing the positive sign bit).

If the resulting sign bit generated via the corresponding adder circuit 204 is “1”, indicating a negative value, the two's complement circuit 212 can perform additional conversion steps. Converting the negative value to two's complement circuit can include inverting the bits of the unsigned shifted value (including the added most significant value of “0”) and adding 1 to the result. The conversion process can be performed using a combination of suitable logic gates, such as XOR gates, AND gates, and OR gates, among others. Each of the two's complement circuits 212 can execute in parallel to process the resulting values of each pair of operand values.

In one example, if the fixed-point value received from the alignment circuit 210 is “1.01101010” (with the decimal added here for clarity), the two's complement circuit 212 can add a most significant zero bit, resulting in “01.01101010” (with the decimal added here for clarity). If the sign bit generated by the corresponding adder circuit 204 is “1,” the two's complement circuit 212 can invert the bits to obtain “10.10010101” and then add 1 to obtain the two's complement value “10.10010110.” In some implementations, each two's complement circuit 212 can include a multiple stages, including a concatenation stage, an inverter stage, an adder stage, and an output stage, where the concatenator stage can add the most significant “0” bit to the input value, the inverter stage can invert the bits of the unsigned shifted value, the adder stage can add 1 to the inverted value, and the output stage can provide the signed output. Each two's complement circuit 212 can provide the signed output to the adder tree circuit 214 for summation.

The MAC circuit 200 can include at least one adder tree circuit 214. The adder tree circuit 214 can perform signed addition to add the resulting signed values generated by each two's complement circuit 212, thereby accumulating the products of the MAC operation. In some implementations, the adder tree circuit 214 can be structured as a binary tree, with each node of the tree representing an adder circuit that adds two input values, allowing the adder tree circuit 214 to efficiently accumulate the signed values from each two's complement circuit 212. In some implementations, the adder tree circuit 214 may include any other type of adder circuit that can add two or more signed values. The adder tree circuit 214 can provide the resulting sum to the sign handler circuit 216, which can further process the result to generate the final output of the MAC circuit 200.

The MAC circuit 200 can include at least one sign handler circuit 216. The sign handler circuit 216 can convert the sum generated by the adder tree circuit 214 from a signed, two's complement format into an unsigned value, while separately preserving the sign bit. For example, if the sum generated by the adder tree circuit 214 is “0101101010”, the sign handler circuit 216 can convert this value into an unsigned value “101101010” and a sign bit “0”, indicating a positive number. The sign handler circuit 216 can perform this conversion by removing the most significant bit. If the sign bit is “0,” the sign handler circuit 216 can provide the value as output, as the number is already in a proper unsigned format with the sign bit removed.

If the sign bit is “1,” indicating a negative number, the sign handler circuit 216 can invert the remaining bits and add one to convert from the two's complement format to an unsigned value format. The sign handler circuit 216 can be structured as a combination of logic gates, such as XOR gates, AND gates, and OR gates, among others, which can execute the conversion in a single clock cycle. The sign handler circuit 216 can provide the unsigned value and the sign bit to the normalization circuit 218, which can further process the result to generate a floating-point output of the MAC operation.

The MAC circuit 200 can include at least one normalization circuit 218. The normalization circuit 218 can perform normalization to generate a floating-point output using the unsigned output of the sign handler circuit 216 and the maximum integer value of the max tree circuit 208. The floating-point output can have a mantissa portion, an exponent portion, and a sign bit. The normalization circuit 218 can generate floating-point outputs have in any floating-point format, including but not limited to 16-bit floating point values, 32-bit floating point values, or 64-bit floating point values, among others. The s normalization circuit 218 can set the sign bit of the output floating-point value to the sign bit extracted by the sign handler circuit 216.

The normalization circuit 218 can generate the mantissa portion of the floating-point output using the unsigned value generated by the sign handler circuit 216. If the unsigned value is not zero, the normalization circuit 218 can left-shift the unsigned value until the most significant “1” in the unsigned value has been shifted off the most significant bit position in the unsigned value. Shifting off the most significant “1” value is used to normalize the mantissa, with the removed “1” position representing an implied “1” of the floating-point value. The number of shift operations can be counted (e.g., by incrementing a counter, etc.) and used to determine the exponent portion of the floating-point output, as described in further detail herein. The shifted value can be zero-padded with any number of least significant bits to match the bit width of the mantissa portion of the floating-point output. The zero-padded shifted value can be used as the mantissa portion of the floating-point output of the normalization circuit 218.

The normalization circuit 218 can generate the exponent portion of the floating-point output using the output of the max tree circuit 208 and the number of left-shift operations used to generate the mantissa. To do so, the normalization circuit 218 can receive the maximum integer component from the max tree circuit 208 and subtract the logarithmic bias from this value to properly represent the exponential portion of the logarithm value. This subtraction of the logarithmic bias is performed because the whole-number portion of the exponent in the logarithm number system format is represented as 2integer-bias, as described herein. The resulting difference can be decremented by the number of left-shift operations performed to generate the mantissa, thereby generating a normalized exponent value for the floating-point output. To represent the normalized exponent value in the floating-point format, the normalization circuit 218 can add a floating-point bias value to the normalized exponent value, such as decimal 15 for 16-bit floating point, 127 for 32-bit floating point, or 1023 for 64-bit floating point, among others. The normalization circuit 218 can concatenate the mantissa value, the biased normalized exponent value, and the sign value to generate the output of the MAC operation in floating point format.

The normalization circuit 218 can be structured as a combination of logic gates and shift registers/circuits, among others, to perform the normalization operation. For example, the normalization circuit 218 can include a left-shifter circuit (e.g., a barrel shifter, serial shifter, etc.) that left-shifts the unsigned value, a counter circuit that counts the number of shift operations performed, a zero-padder circuit (e.g., multiplexors, etc.) that zero-pads the shifted value, and one or more arithmetic circuits that generate the biased normalized exponent value. In some implementations, the various components of the MAC circuit 200 can operate in a pipeline parallel configuration to improve overall throughput and performance for MAC operations. The floating-point output of the normalization circuit 218 can be provided as the output of the MAC circuit 200, which can be used in various applications, such as artificial intelligence operations, among others.

FIG. 3 illustrates a diagram 300 of an example exponential function circuit 302 that may be implemented as part of the example MAC circuits described herein, in accordance with some embodiments. The exponential function circuit 302 may be implemented, for example, as one or more of the exponent circuits 206 of FIG. 2. In some implementations, the exponential function circuit 302 is provided as an individual IC device. In some implementations, the exponential function circuit 302 is included as a part of a larger IC device which comprises circuitry other than the memory device for other functionalities. The exponential function circuit 302 is shown as receiving a logic high output from the logic high circuit 304, a first NOR gate 306, a first NAND gate 308, a second NAND gate 310, a NOT gate 312, a third NAND gate 314, a second NOR gate 316, a fourth NAND gate 318, and a third NOR gate 320.

Various embodiments of the circuits and logic gates that implement the exponential function circuit 302 may include various transistors. The transistors described herein may have a certain type (n-type or p-type), but embodiments are not limited thereto. The transistors can be any suitable type of transistor including, but not limited to, MOSFET, CMOS transistors, PMOS, NMOS, BJT, high voltage transistors, high frequency transistors, PFETs/NFETs, FinFETs, planar MOS transistors with raised source/drains, nanosheet FETs, nanowire FETs, or the like. It should be understood that the exponential function circuit 302 shown in FIG. 3 can be a portion of a larger processing circuit that includes memory elements and/or additional logic gates.

In this example, the exponential function circuit 302 can be a lookup table for fixed-point binary decimal values for exponent operations. As described herein, the fraction component can contribute to the number represented by the logarithm number system value according to

$${2}^{\frac{fraction}{N}} ,$$

where N represents the resolution of the fractional component generated by an adder circuit, as described in connection with FIG. 2. In this example, the exponential function circuit 302 can receive an input value with three bits, shown as IN[0], IN[1], and IN[2]. The number of bits in the input value can be equal to log₂(N), such that the resolution of the input fraction value is captured and converted into a corresponding fixed-point output. In this example, the fraction portion can represent eight values (e.g., where N is equal to 8), ranging from zero to 7.

In this example, the exponential function circuit 302 is implemented to generate an output of four bits, shown here as OUT[0], OUT[1], OUT[2], and OUT[3]. Although four bits are shown here, it should be understood that any suitable resolution of output may be used in connection with the MAC circuits described herein. The output of the exponential function circuit 302 is generated using a set of logic gates. However, any suitable approach may be used to implement a lookup table. For example, in some implementations, the exponential function circuit 302 may be implemented using alternative logic gate configuration(s) and/or memory elements to generate the exponential fixed-point output value corresponding to the input fractional component.

The exponential function circuit 302 is shown as including a logic high circuit 304 that outputs a logic high as OUT[3]. The most significant bit of the fraction is always 1, as two raised to any positive fractional exponent is always between one and two. The first NOR gate 306 is shown as receiving IN[0] and IN[1] as input and providing a corresponding output to the third NAND gate 314 and the second NOR gate 316. The second NAND gate 308 that can receive IN[0] and IN[1] as input and can provide a corresponding output to the fourth NAND gate 318. The NOT gate 312 can receive and invert IN[2] and provide the output to the second NOR gate 316.

The third NAND gate 314 can receive the output of the first NOR gate 306 and IN[2], and provides a corresponding output to the fourth NAND gate 318. The second NOR gate 316 is shown as receiving the outputs of the NOT gate 312 and the first NOR gate 306, and generating OUT[2] as output. The fourth NAND gate 318 is shown as receiving the outputs of the first NAND gate 308 and the third NAND gate 314, and generating OUT[1] as output. The third NOR gate 320 can receives IN[0] and the output of the second NAND gate 310 as input, and can generate OUT[0] as output. An example truth table for different fractional component inputs represented in both binary and fractional format, and their corresponding outputs, are provided in the following table.

TABLE 1

| | Output (fixed-point |
|---|---|
| Input | binary decimal value) |

| | | | |
|---|---|---|---|
| 000 | 0 | 1.000 | 2⁰ |
| 001 | 1/8 | 1.000 | 2^{1/8} |
| 010 | 2/8 | 1.001 | 2^{2/8} |
| 011 | 3/8 | 1.010 | 2^{3/8} |
| 100 | 4/8 | 1.011 | 2^{4/8} |
| 101 | 5/8 | 1.100 | 2^{5/8} |
| 110 | 6/8 | 1.101 | 2^{6/8} |
| 111 | 7/8 | 1.110 | 2^{7/8} |

Although the foregoing example provides three decimal places of precision (not counting the logic high most-significant bit), it should be understood that the output of the exponential function circuit 302 can have any suitable precision. For example, the precision of the exponential function circuit 302 may not necessarily be a function of the fraction component itself. In some implementations, the precision of the output of the exponential function circuit 302 can be selected to conform to the bit width of the mantissa portion of the floating-point output of the MAC circuit in which the exponential function circuit 302 operates.

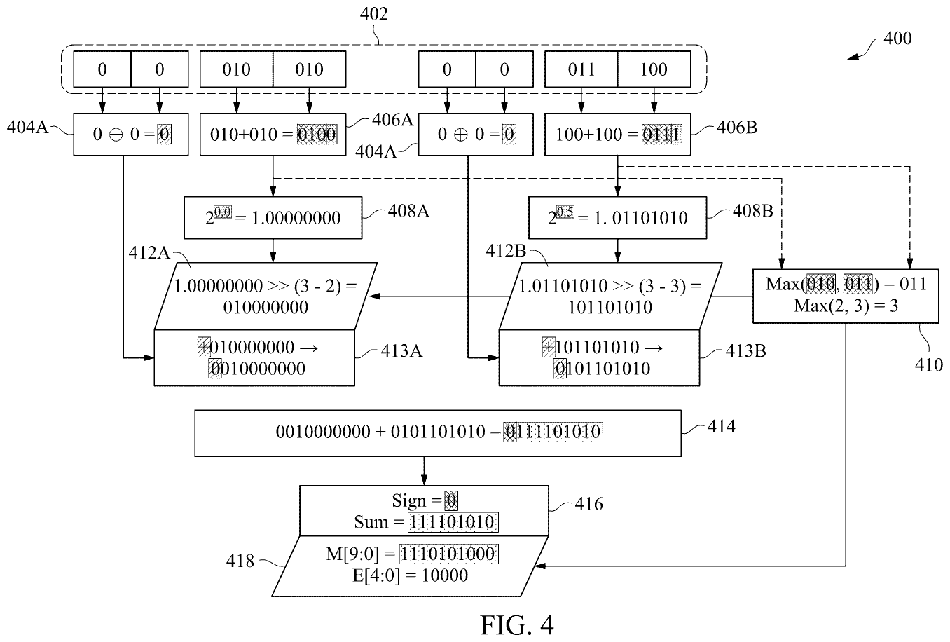

FIG. 4 illustrates a data flow diagram 400 showing how an example MAC operation can be performed using the example MAC circuit of FIG. 2, in accordance with some embodiments. The data float diagram is shown in a similar format to the MAC circuit 200 of FIG. 2, with like elements corresponding to like operations described in connection with FIG. 2. In this example, the data flow diagram 400 shows processing of two different operands, each with two values having the logarithmic number system format I2F1. In the I2F1 format, the most significant bit represents the sign of the number, the two middle bits represent the integer value of the exponent, and the least significant bit represents the fraction component of the exponent. In this example, the resolution of the fraction component is 2, as the least significant bit can either be 0 or 1. The first two values of the input operands 402 are each “0010.” The second two values of the input operands 402 are “0011” and 0100.”

At steps 404A and 404B, an XOR operation is performed to calculate the sign values of a multiplication operation between the two operands. As all values are positive, the generated sign bits are equal to “0.” At steps 406A and 406B, the integer and fraction components (treated as a single number) are added together to perform a multiplication operation, resulting in the output values 0100 and 0111, with 0 and 1 respectively corresponding to the fraction component of the sums. At step 410, a max circuit (e.g., the max tree circuit 408) performs a MAX operation between the integer components of the sums generated in steps 406A and 406B (shown here as “010” and “011,” respectively), which in this example outputs the binary value “011.”

At steps 408A and 408B, the fraction component of the sums generated in steps 406A and 406B are used to evaluate the exponent expression 24, where X is the input fraction component of each sum. Step 408A generates the value “1.00000000” (decimal added for clarity) and step 408B generates the value “1.01101010” (decimal added for clarity). At steps 412A and 412B, the evaluated exponential calculated at steps 408A and 408B are right-shifted by the max integer value minus the integer value generated at steps 406A and 406B, respectively. At step 412A, the maximum value is “011” (decimal 3) and the corresponding integer value is “010” (decimal two), and so the value “1.00000000” is right-shifted by one (three minus two). This results in the value “0100000000,” as shown. At step 412B, the max integer value is equal to the corresponding integer value, so no shifting operation is performed.

At steps 413A and 413B, the shifted outputs of steps 412A and 412B are converted into two's complement format. In this example, both values are positive, and the conversion includes adding a most significant “0” bit for each value. At step 414, both converted values are summed (e.g., using an adder tree circuit such as the adder tree circuit 216 of FIG. 2). The sum can be a signed sum, resulting in a sign bit and output value, as shown. At step 416, the sum can be converted back from two's complement into an unsigned format, while separately preserving the sign bit. As the value generated at step 414 is positive, no conversion steps are performed aside from removing the most-significant bit (the sign bit) from the output value.

At step 418, the sum is normalized to generate a 16-bit floating point value. As described herein, normalizing can include left-shifting the value generated at step 416 until the most significant “1” bit is removed from the value (e.g., the implicit 1 bit in floating point format). In this example, the most significant bit is already “1,” so only one shift operation occurs. The shifted value is used as the mantissa, which is zero-padded with an additional least-significant “0” bit to conform to the 10-bit size of this portion of the 16-bit floating point standard. This results in the mantissa value M [9:0] of “1110101000.” The 5-bit exponent value E [4:0] is calculated by first subtracting the logarithmic bias (e.g., decimal “1” for the I2F1 format, shown here) from the maximum integer value generated at step 410, and then decrementing this difference for each time the mantissa value was left-shifted. As the mantissa value was left-shifted one time, this value is decremented once, resulting in a decimal value of “1.” To conform with the 16-bit floating point standard, a bias value of decimal “15” (binary 1111) is added to the decremented value, setting the normalized exponent E [4:0] to decimal “16” (shown here as binary “10000”). The most significant bit of the floating-point output can be set to the sign bit extracted at step 416.

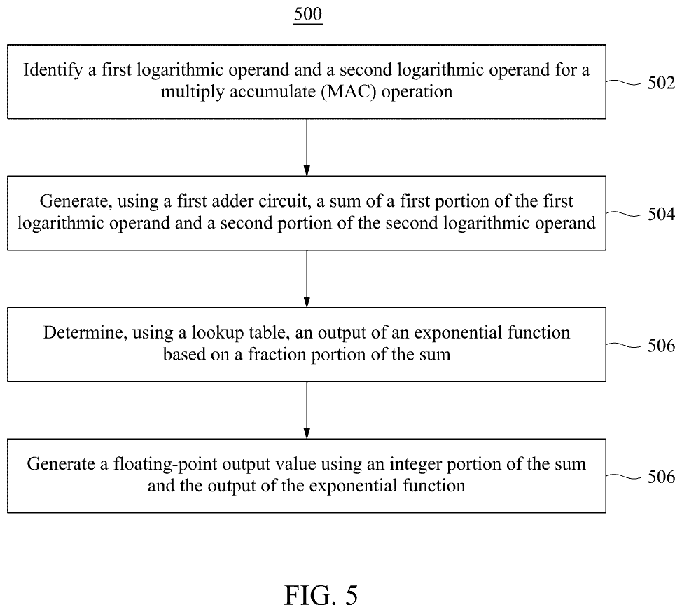

FIG. 5 illustrates a flowchart of an example method 500 of operating an example MAC circuit for logarithm number system values, in accordance with some embodiments. The method 500 may be used to operate a MAC circuit (e.g., the logarithm number system MAC circuit 116, the MAC circuit 200, etc.). It is noted that the method 500 is merely an example and is not intended to limit the present disclosure. Accordingly, it is understood that additional operations may be provided before, during, and after the method 500 of FIG. 5, and that some other operations may only be briefly described herein.

In brief overview, the method 500 starts with operation 502 of identifying a first logarithmic operand and a second logarithmic operand for a MAC operation. The method 500 proceeds to operation 504 of generating, using a first adder circuit, a sum of a first portion of the first logarithmic operand and a second portion of the second logarithmic operand. The method 500 proceeds to operation 506 of determining, using a lookup table, an output of an exponential function based on a fraction portion of the sum. The method 500 proceeds to operation 508 of generating a floating-point output value using an integer portion of the sum and the output of the exponential function.

Referring to operation 502, the method 500 can include identifying a first logarithmic operand (e.g., A[0]) and a second logarithmic operand (e.g., B[0]) for a MAC operation. The first logarithmic operand and the second logarithmic operand can be represented in a logarithmic number system format, such as I2F1 or any other similar format. In the I2F1 format, the most significant bit represents the sign of the number, the two middle bits represent the integer value of the exponent, and the least significant bit represents the fraction component of the exponent. Each of the input operands may be provided and/or accessed by an accelerator circuit to perform a MAC operation. In some implementations, the first and second logarithmic operands may be two corresponding values in a vector or tensor data structure. In such implementations, the MAC circuit may accumulate all values of the data structure in parallel, as described in connection with FIGS. 2 and 4.

Referring to operation 504, the method 500 can include generating, using a first adder circuit (e.g., the adder circuit 204, etc.), a sum of a first portion (e.g., integer portion together with the fraction portion) of the first logarithmic operand and a second portion (e.g., integer portion together with the fraction portion) of the second logarithmic operand. For example, the first adder circuit can perform an addition operation to sum the integer and fraction components of the first and second logarithmic operands. The resulting integer portion and fractional component of the sum can be used to calculate additional intermediate values of the MAC operation.

Referring to operation 506, the method 500 can include determining, using a lookup table (e.g., the exponent circuit 206, the exponent function circuit 302, etc.), an output of an exponential function based on a fraction portion of the sum. The lookup table may be implemented using one or more logic gates, such as the exponent circuit 302 described in connection with FIG. 3. In some implementations, the lookup table can be implemented using other types of digital logic circuit, such as a ROM memory or a PLA. The lookup table can receive the fraction portion of the sum as input and generate the output of the exponential function as output. The lookup table can perform the exponential function, such as 24, where X is the fraction portion of the sum.

Referring to operation 508, the method 500 can include generating a floating-point output value using an integer portion of the sum and the output of the exponential function. The floating-point output value can be represented in a floating-point format, such as a 16-bit floating-point format. To generate the floating-point output value, the exponential function output generated at operation 506 can be converted into a two's complement format based on an XOR-of the signs of the two values being multiplied, as described herein. Twos' complement values generated from any multiple inputs of the MAC circuit can be accumulated, for example, using an adder tree circuit, as described herein.

The resulting sum can from the adder tree circuit can be converted into an unsigned value, with the sign value separately preserved. The sum can then be left-shifted until the most significant “1” bit has been shifted off from the sum value. The left-shifted value can be used as the mantissa portion of the floating-point output, which may be zero-padded with least significant bits as needed to conform to the bit width of the output floating-point format. The exponent of the floating-point output can be determined by using the maximum (e.g., greatest) exponent value of each resulting sum of the inputs to the MAC circuit (e.g., the output of the max tree circuit 208 of FIG. 2). The logarithmic bias value corresponding to the logarithm number system format of the input data can be subtracted from the maximum exponent value, and this difference can be decremented according to the number of times the mantissa value was left-shifted, to generate the normalized exponent value. A floating-point bias value can be added to the normalized exponent value to conform to the output floating-point format. The size of the floating-point bias value can depend on the specific floating-point format being output by the MAC circuit. The sign value, the exponent value, and the mantissa can be concatenated to generate the floating-point output value, as described in connection with FIGS. 2 and 4.

In one aspect of the present disclosure, a MAC circuit is disclosed. The MAC circuit can include one or more circuits configured to receive a first operand comprising a plurality of first values and a second operand comprising a plurality of second values, each of the plurality of first values and the plurality of second values formatted according to a logarithm number system. The one or more circuits can generate a plurality of sums between a respective first portion of each of the plurality of first values and a respective second portion of each of the plurality of second values, each of the plurality of sums comprising a respective integer portion and a respective fraction portion. The one or more circuits can determine a plurality of exponential values using the respective fraction portion of the plurality of sums. The one or more circuits can generate a mantissa portion for a floating-point value based on the plurality of exponential values. The one or more circuits can generate an exponent portion for the floating-point value based on the respective integer portion of the plurality of sums. The one or more circuits can provide the floating point value as output.

In another aspect of the present disclosure, an accelerator device is disclosed. The accelerator device can include a memory circuit and a processing core circuit. The processing core circuit can include a data memory and a MAC circuit. The data memory can store a first operand formatted according to a logarithm number system format and a second operand formatted according to the logarithm number system format. The MAC circuit can access the first operand and the second operand according to a MAC instruction. The MAC circuit can generate an output value using the first operand and the second operand based on the MAC instruction, the output value formatted according to a floating-point format. The MAC circuit can provide the output value for storage in the memory circuit.

In yet another aspect of the present disclosure, a method is disclosed. The method can include identifying, by a MAC circuit, a first logarithmic operand and a second logarithmic operand for a MAC operation. The method can include generating, by a first adder circuit of the MAC circuit, a sum of a first portion of the first logarithmic operand and a second portion of the second logarithmic operand. The method can include determining, by a lookup table of the MAC circuit, an output of an exponential function based on a fraction portion of the sum. The method can include generating, by the MAC circuit, a floating-point output value using an integer portion of the sum and the output of the exponential function.

As used herein, the terms “about” and “approximately” generally mean plus or minus 10% of the stated value. For example, about 0.5 would include 0.45 and 0.55, about 10 would include 9 to 11, about 1000 would include 900 to 1100.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A multiply accumulate circuit (MAC), comprising:
one or more circuits configured to:
receive a first operand comprising a plurality of first values and a second operand comprising a plurality of second values, each of the plurality of first values and the plurality of second values formatted according to a logarithm number system;
generate a plurality of sums between a respective first portion of each of the plurality of first values and a respective second portion of each of the plurality of second values, each of the plurality of sums comprising a respective integer portion and a respective fraction portion;
determine a plurality of exponential values using the respective fraction portion of the plurality of sums;
generate a mantissa portion for a floating-point value based on the plurality of exponential values;
generate an exponent portion for the floating-point value based on the respective integer portion of the plurality of sums; and
provide the floating-point value as output.

2. The MAC circuit of claim 1, wherein the one or more circuits comprise a plurality of adder circuits each configured to generate a respective one of the plurality of sums.

3. The MAC circuit of claim 1, wherein the one or more circuits comprise a plurality of exponential circuits each configured to generate a respective one of the plurality of exponential values.

4. The MAC circuit of claim 3, wherein the plurality of exponential circuits comprise one or more of a set of logic gates defining a lookup table, a read-only memory (ROM), or a programmable logic array (PLA).

5. The MAC circuit of claim 1, wherein the one or more circuits are further configured to:
generate a plurality of two's complement values using the plurality of exponential values;
accumulate the plurality of two's complement values to generate an intermediate value; and
generate the mantissa portion for the floating-point value based on the intermediate value.

6. The MAC circuit of claim 5, wherein the one or more circuits are further configured to:
convert the intermediate value into an unsigned format to generate an unsigned value; and
generate the mantissa portion by shifting the unsigned value based on a number of leading binary zeroes of the unsigned value.

7. The MAC circuit of claim 5, wherein the one or more circuits comprise an adder tree circuit configured to accumulate the plurality of two's complement values.

8. The MAC circuit of claim 1, wherein the one or more circuits are further configured to:
determine, using a maximum operation, a greatest integer portion of the plurality of sums; and
generate the exponent portion for the floating-point value based on the greatest integer portion of the plurality of sums.

9. The MAC circuit of claim 8, wherein the one or more circuits comprise a max tree circuit configured to receive the respective integer portion of the plurality of sums and generate the greatest integer portion as output.

10. The MAC circuit of claim 1, wherein the one or more circuits are further configured to generate a plurality of sign values for the plurality of sums using a plurality of XOR operations.

11. An accelerator device, comprising:
a memory circuit;
a processing core circuit comprising:
a data memory storing a first operand formatted according to a logarithm number system format and a second operand formatted according to the logarithm number system format; and
a multiply-accumulate (MAC) circuit configured to:
access the first operand and the second operand according to a MAC instruction;
generate an output value using the first operand and the second operand based on the MAC instruction, the output value formatted according to a floating-point format; and
provide the output value for storage in the memory circuit.

12. The accelerator device of claim 11, wherein the processing core circuit comprises an instruction memory configured to store the MAC instruction to invoke the MAC circuit.

13. The accelerator device of claim 11, wherein the first operand comprises a plurality of first values formatted according to the logarithm number system format and the second operand comprises a plurality of second values formatted according to the logarithm number system format.

14. The accelerator device of claim 11, wherein the MAC circuit is further configured to: generate at least one sum based on the first operand and the second operand;
generate at least one exponential value using the at least one sum; and
determine a mantissa portion of the output value using the at least one exponential value.

15. The accelerator device of claim 14, wherein the MAC circuit is further configured to generate an exponent portion of the output value using an integer portion of the at least one sum.

16. The accelerator device of claim 14, wherein the MAC circuit comprises an exponential circuit configured to receive a fraction portion of the at least one sum and generate the at least one exponential value, wherein the exponential circuit comprises one or more of a set of logic gates defining a lookup table, a read-only memory (ROM) lookup table, or a programmable logic array (PLA).

17. A method, comprising:
identifying, by a multiply-accumulate (MAC) circuit, a first logarithmic operand and a second logarithmic operand for a MAC operation;
generating, by a first adder circuit of the MAC circuit, a sum of a first portion of the first logarithmic operand and a second portion of the second logarithmic operand;
determining, by a lookup table of the MAC circuit, an output of an exponential function based on a fraction portion of the sum; and
generating, by the MAC circuit, a floating-point output value using an integer portion of the sum and the output of the exponential function.

18. The method of claim 17, wherein the output of the exponential function is a first output of a first exponential function, and further comprising generating, by the MAC circuit, an accumulated value based on the first output of the first exponential function and a second output of a second exponential function, wherein the second output of the second exponential function is generated based on a third logarithmic operand and a fourth logarithmic operand.

19. The method of claim 18, further comprising generating, by the MAC circuit, a mantissa portion of the floating-point output value based on a shift operation, the first output of the first exponential function, and the second output of the second exponential function.

20. The method of claim 17, further comprising generating an exponent portion of the floating-point output value based on an integer portion of the sum.
